(19) United States
(12) Patent Application Publication
(10) Pub. No.: US 2016/0050104 A1
(43) Pub. Date: Feb. 18, 2016

(54) NETWORK DEVICE ARCHITECTURE ADJUSTMENTS

(71) Applicant: HEWLETT-PACKARD DEVELOPMENT COMPANY, L.P., Houston, TX (US)

(72) Inventors: Shaun Wackerly, Roseville, CA (US); Robert L. Faulk, Roseville, CA (US); Damien Keehn, Roseville, CA (US)

(21) Appl. No.: 14/777,497

(22) PCT Filed: Mar. 15, 2013
(86) PCT No.: PCT/US2013/032124

§ 371 Date: Sep. 15, 2015

(51) Int. Cl. H04L 12/24; H04L 12/741

(52) U.S. Cl. CPC H04L 41/0668; H04L 41/12; H04L 45/74

(57) ABSTRACT

An example method of adjusting network device architecture can include sending a network decision from a controller to at least one network device that communicates units of data through a network infrastructure, the network decision based on information received from a number of network devices on the network infrastructure. The method can include adjusting the network device architecture for the at least one network device based on the network decision sent by the controller.

### BACKGROUND

A sufficiently large set of active servers may exceed a data routing capability of a static network. Improvement of data routing performance may be accomplished by an administrator adding more routers, switches, hubs, or bridges to a network. Such additions may involve changes in data traffic pathways to be reflected in other devices on the network. Such changes may be communicated via a data traffic protocol or by manually modifying data traffic tables of each neighboring router, switch, hub, or bridge. To enable servers to utilize an added router, switch, hub, or bridge, server data traffic tables may also need to be modified.

These changes to the network and servers may be costly and/or time-consuming. Since such changes may disrupt the network, they are likely to be performed during a network downtime and these changes may remain long-term.

### BRIEF DESCRIPTION OF THE DRAWINGS

FIG. 1 illustrates a block diagram of an example of a method of adjusting network device architecture according to the present disclosure.

FIGS. 2A-2B illustrate block diagrams of examples of adjusting network device architecture using replacement network devices according to the present disclosure.

FIGS. 3A-3C illustrate block diagrams of examples of adjusting network device architecture for downstream data traffic according to the present disclosure.

FIGS. 4A-4C illustrate block diagrams of examples of adjusting network device architecture for upstream data traffic according to the present disclosure.

FIG. 5 illustrates a block diagram of an example system for adjusting network device architecture in a cloud according to the present disclosure.

FIG. 6 illustrates a block diagram of an example controller for adjusting network device architecture according to the present disclosure.

### DETAILED DESCRIPTION

Computing networks may include multiple network devices, such as routers, switches, hubs, and/or bridges, and may include computing devices, such as servers, desktop PCs, laptops, workstations, and mobile devices, along with peripheral devices (e.g., printers, facsimile devices, and scanners, etc.), networked together (e.g., in a cloud) across wired and/or wireless local and/or wide area network (LANs/WANs).

The present disclosure describes providing controller-driven dynamic adjustments to improve resiliency, scalability, and/or performance for network devices (e.g., routers, switches, hubs, and/or bridges, etc.) that communicate units of data (e.g., packets, frames, etc.) through a network infrastructure. Such controller-driven dynamic adjustments can be accomplished using, for example, a number of standby network devices, a defined throughput capacity utilization for network devices (e.g., enabled by load balancing), scalability of network device utilization (e.g., an ability to increase and decrease a number of network devices being utilized at a particular time, for a particular job, etc., based on a current load and/or predicted load), virtualization of network devices, and/or utilization of network device resources in a cloud, among other controller-driven adjustments to network device architecture.

Systems, apparatuses, machine readable media, and methods for adjusting network device architecture are provided herein. An example method of adjusting network device architecture can include sending a network decision from a controller to at least one network device that communicates units of data (e.g., packets, frames, etc.) through a network infrastructure, the network decision based on information received from a number of network devices on the network infrastructure. The method can include adjusting the network device architecture for the at least one network device based on the network decision sent by the controller. As utilized herein, “a network decision” can, for example, indicate a decision affecting a configuration of a number of network devices and/or can, for example, indicate a decision affecting forwarding of units of data (e.g., via a data traffic pathway) via a number of network devices on the network infrastructure.

Individual network devices may have a limited throughput capacity. For example, hardware-based network devices may have higher performance than software-based network devices, but hardware-based network devices may be less flexible and/or more costly. Software-based network devices may have lower performance than hardware-based network devices, but software-based network devices may have greater flexibility. Network devices may be grouped to increase their collective performance beyond that of any individual network device. For example, on a software-defined network (SDN), multiple network devices (e.g., in the cloud) can be controlled by a single entity (e.g., a controller). A number of such controllers (e.g., one or more controllers) may be utilized as described in the present disclosure to, for example, dynamically scale the network devices in a network device group to achieve a desired level of performance based on traffic content, current and/or predicted load, or other controller-visible factors. Among other benefits described herein, these controller-driven adjustments to network device architecture can dynamically provide resiliency, scalability, and/or performance improvement, for example, without affecting data traffic tables of network end-hosts.

As utilized herein, the term “resiliency” can indicate an ability of a network infrastructure to dynamically withstand failure of at least one network device (e.g., routers, switches, hubs, and/or bridges, etc.) without having an effect on an end-user's experience (e.g., at the end-host), such as units of data on the network being dropped, potentially leading to delays and/or slowness of data traffic. As utilized herein, the term “scalability” can indicate an ability of a network infrastructure to dynamically increase and decrease a number of network devices being utilized at a particular time, for a particular job, etc., based on controller-visible factors, as described herein, which can reflect demand for computing resources by an end-user through a number of end-hosts. The term “scalability” also can indicate selection of a particular network device from among a plurality of network devices (e.g., a data traffic pathway) based on the controller-visible factors, as described herein. The improvements in resiliency and/or scalability, among other features described herein, can improve performance of the network through adjusting the network device architecture.

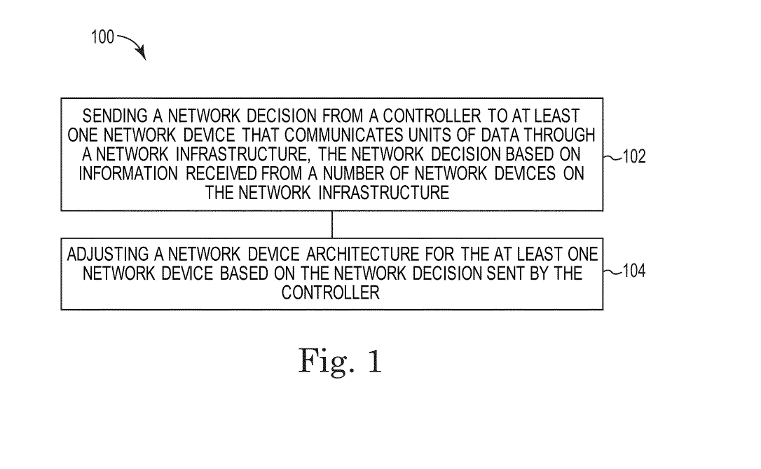

FIG. 1 illustrates a block diagram of an example of a method of adjusting network device architecture according to the present disclosure. Unless explicitly stated, the method examples described herein are not constrained to a particular order or sequence. Additionally, some of the described method examples, or elements thereof, can be performed at the same, or substantially the same, point in time. As described herein, the actions, functions, calculations, data manipulations and/or storage, etc., can be performed by execution of non-transitory machine readable instructions stored in a number of memories (e.g., software, firmware, and/or hardware, etc.) of a number of applications. As such, a number of computing resources with a number of interfaces (e.g., graphical user interfaces (GUIs), computers, servers, and/or physical (e.g., hardware) and/or virtual (e.g., virtual machine (VM) end-hosts, etc.) can be utilized for dynamically providing network device resiliency, scalability, and/or performance through cloud service providers (e.g., via accessing a number of computing resources in “the cloud”) as driven (e.g., implemented) by a number of controllers, as described herein.

In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, communication, and/or structural changes may be made without departing from the scope of the present disclosure. As used herein, “a” or “a number of” an element and/or feature can refer to “one or more” of such elements and/or features. Further, where appropriate, as used herein, “for example” and “by way of example” should be understood as abbreviations for “by way of example and not by way of limitation”.

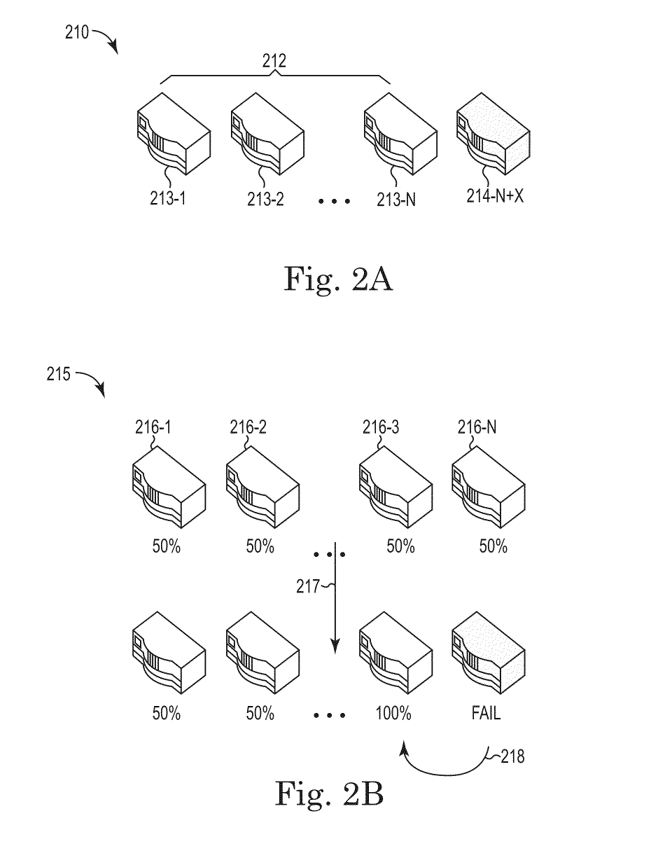

The figures herein follow a numbering convention in which the first digit or digits correspond to the figure number of the drawing and the remaining digits identify an element or component in the drawing. Similar elements or components shared between different figures may be identified by the use of similar digits. For example, 111 may reference element “11” in FIG. 1 and a similar element may be referenced as 211 in FIG. 2. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

As shown in block 102 of FIG. 1, the method 100 of adjusting network device architecture can include sending a network decision from a controller to at least one network device that communicates units of data through a network infrastructure, the network decision based on information received from a number of network devices on the network infrastructure. The network decision sent by the controller to the at least one network device can be based on information (e.g., from among the range of controller-visible factors that are described in the present disclosure) received from a number of network devices on the network infrastructure, which in various circumstances may not include the at least one network device to which the network decision is sent. For example, both may be the same network device if there is only one network device or the network decision can be sent to or the information can be received from pluralities of network devices that may be different in number or may not even overlap.

As described herein, a network device can be conceptualized as a physical or virtual device that can communicate units of data within a network or from one subnetwork (e.g., subnet) to another subnetwork based on a destination address of the unit of data and/or policies either configured by and/or learned from neighboring network devices, and/or a controller, as described herein. A virtual network device can be conceptualized as ranging from one subportion of a physical network device (e.g., a VM) through a collection of physical network devices operating as one network device (e.g., in the cloud or otherwise), along with mixtures thereof. The virtual network device may have a variety of features that enable the network device to operate independent of other network devices.

The method 100 can include adjusting the network device architecture for the at least one network device based on the network decision sent by the controller, as shown in block 104 of FIG. 1. One controller, as described herein, can be conceptualized as a single logical entity that makes configuration and/or forwarding decisions for one or more components (e.g., physical and/or virtual network devices) of the network infrastructure. As described herein, functional implementations of controllers related to selection of network device groups and/or particular network devices for communicating units of data can be based on any factor that is visible to the controller, which in various examples can be a single factor or any combination of such single factors (e.g., two or more factors). The controller-visible factors related to a number of network devices can, for example, include physical proximity, network proximity, current load and/or predicted load (e.g., a percentage of network device throughput capacity), weighted round-robin (e.g., for adjacency selection), traffic content, administrator preference, time since a last incident, resource cost, and/or resource power consumption, among other such network device-related factors and related to connections between the network devices. The controller-visible factors can be applied in a process for network device selection as a whole and/or for individual network device selection when redistributing network devices (e.g., for a data traffic pathway) after a network device failure, as described herein. The term “controller-visible factors” is utilized in various contexts throughout this disclosure and the definition thereof is consolidated here for ease of reference.

An administrator, as utilized herein, can be a person and/or organization responsible for configuration of the controller, the network infrastructure, and/or the end-hosts. The administrator may delegate pools of these resources to a specific tenant for that tenant's use. For instance, the administrator may purchase resources and then bill the tenant for their usage of those resources. The tenant can be a person and/or organization responsible for configuring a subset (e.g., one or more subnetworks) of all network infrastructure and/or end-hosts. However, the tenant does not configure the controller. The tenant may be permitted by the administrator to allocate new network infrastructure and/or end-hosts. An end-host can be a physical or virtual GUI, computer, server, VM, etc., that communicates units of data through a number of network devices on the network infrastructure between the end-host and a network core.

In various examples, the network core and/or each end-host can be conceptualized as a compute node (e.g., a single logical machine that houses multiple VMs by dividing memory and/or processing resources). The end-hosts can be utilized by any tenant seeking services provided by the network core through the network devices on the network infrastructure. In various examples, as described herein, tenants can access the network core utilizing a number of dynamically variable network device configurations in the cloud (e.g., virtual network devices). By way of example and not by way of limitation, such tenants can include Internet service providers, business organizations, and research groups, among many other possibilities.

In some examples, the SDN can be configured by or through the controller. An SDN can be a form of network virtualization in which the control plane is separated from the data plane and implemented in a software application. Network administrators can therefore have programmable centralized control of network traffic without requiring physical access to the network's hardware devices. The controller can include a processing resource in communication with a memory resource. The memory resource can include a set of instructions executable by the processing resource to perform a number of functions described herein. In some examples, the controller can be a discrete device, such as a server. In some examples, the controller can be a distributed network controller, for example, such as a cloud-provided functionality. One example of a protocol for SDN is Open Flow, which is a communications protocol that gives access to the forwarding plane of a network device over the network. Some examples of the present disclosure can operate according to an OpenFlow, or other SDN protocol, and/or a hybrid of an SDN protocol combined with “normal” networking (e.g., on a hardware distributed control plane).

FIGS. 2A-2B illustrate block diagrams of examples of adjusting network device architecture using replacement network devices according to the present disclosure. The present disclosure describes a number of data traffic-centric goals, including resiliency and scalability, which can be utilized for improvements in network device performance. Examples contributing to such goals are described separately herein, however, such examples and variants thereof may be combined in various ways to substantially simultaneously accomplish, for example, both improved resiliency and scalability for improvements in network device performance.

A network (e.g., a SDN, as described herein) can have a number of controllers that dynamically allocate network devices for the purpose of resiliency. Achieving such resiliency can be accomplished by effectively utilizing a pool of available network devices to reduce an effect on an end-user's experience (e.g., at the end-host) in an event such as failure of one or more network devices. An example of such network device failure can be caused by over-utilization of network devices that compromises the end-user experience by contributing to units of data on the network being dropped, potentially leading to delays and/or slowness of communicating the data.

FIG. 2A illustrates a block diagram of an example of providing network device resiliency 210 using standby network devices according to the present disclosure. Improvement of resiliency in the network (e.g., the SDN) can be accomplished by creating a number network device groups 212 having, for example, a plurality of network devices (e.g., network devices 213-1, 213-2, . . . 213-N). Each network device group 212 can, for example, have a number of standby network devices 214-N+X. For example, if the administrator intends a group of network devices of size N to withstand X failures, the administrator can allocate X standby network devices, such that a total of N+X devices are allocated. In some examples, the standby network devices 214-N+X for the group 212 of network devices can be assigned by the controller. In some examples, the standby network devices 214-N+X do not actively handle data traffic until a failure occurs with a network device in the group 212. Following such a failure, the standby network devices 214-N+X can take over for (e.g., replace the throughput capacity of) the failed network device in its assigned group 212. The network devices in the network device group 212 can, in various examples, be determined by the controller based upon the controller-visible factors, as described herein. When any network device within the group 212 fails, the standby network devices 214-N+X for the group can take over for that network device. As such, the present disclosure describes, for example, dynamically configuring at least one group of network devices to have at least one standby network device to provide resiliency in an event of failure of at least one network device in the group of network devices by forwarding throughput of a failed network device to the at least one standby network device.

In various examples, each standby network device can keep current with network changes so that it can take over without requiring a network learning period immediately after the failure was detected. Such a network learning period could result in end-users experiencing data communication slowness, delays, and/or outages during the learning process. If the standby network device was unable to keep current (e.g., due to resource and/or complexity constraints), then a short period of data communication slowness, delays, and/or outages immediately following the failure event may occur while the learning process occurs.

In some examples, assignment of network devices to particular groups can be determined by the administrator. The administrator can delegate this decision to one or more controller, where each controller could change its tuning (e.g., configuration and/or forwarding decisions) based upon the controller-visible factors. By changing the network device group size, for example, the tuning can be catered more toward network device resiliency or more toward network device utilization. The network device utilization could vary from 50% (e.g., a single active network device per network device group and a single standby network device assigned to the group) to approximately 99% (e.g., every active network device in the network being in the same group and a single standby network device assigned to the group). With approximately 99% network device utilization, the network, depending upon the number of network devices therein, may not be able to withstand a single network device failure (e.g., thereby having low resiliency). With 50% network device utilization, half of the active network devices within the network could fail and end-users would not observe a decrease in performance (e.g., thereby having high resiliency).

A network device capacity portion utilization can be determined, for example, by having N=a total number of network devices and X=a number of network device failures (0, . . . , N-1) the network is prepared to withstand. As such, the portion of the capacity to be utilized for each network device prior to any failure=(1−X/N), which can result in various capacity utilizations other than 50% (e.g., capacity utilizations such as 66%, 83%, among many other possibilities). As such, the present disclosure describes adjusting a plurality of network devices to utilize no more than a predetermined portion of a data throughput capacity for each network device for resiliency in an event of failure of at least one network device by forwarding throughput of a failed network device to at least one other network device.

FIG. 2B illustrates a block diagram of another example of providing network device resiliency 215 using replacement network devices according to the present disclosure. Improvement of resiliency in the network (e.g., the SDN) can be accomplished by having a plurality of network devices (e.g., network devices 216-1, 216-2, . . . 216-N) assigned to a group (e.g., a particular subnetwork) prior to failure. Resiliency can be improved by preventing (e.g., by the controller) any single network device from being more than 50% utilized (e.g., having more than 50% of any particular network device's throughput capacity from being utilized and/or loaded more than 50%). Once a network device reaches or is expected to reach 50% utilization, the controller can allocate a portion of the load to a new network device. For example, when a failure occurs 217, the controller can assign a replacement network device (e.g., a neighboring network device) to handle data traffic that was previously handled by the failed network device 218. That is, before any failure has occurred, the controller can limit every network device to not being more than 50% utilized and, upon failure, the controller can select another network device to handle the traffic for the failed network device. As such, the present disclosure describes, for example, dynamically configuring a plurality of network devices to utilize no more than half of a network device throughput capacity for each network device to provide resiliency in an event of failure of at least one network device by forwarding throughput of a failed network device to at least one other network device.

For example, if a selected replacement network device has less than 50% utilization, it will be able to completely assume the data traffic from the failed network device. In some instances, the controller can make the selected network device respond for the failed network device's L3 address with the failed network device's MAC address. In some instances, the replacement network device can handle a subset of the data traffic handled by the failed network device. If multiple network device failures occur, or if an administrator preference or network conditions determine that it is preferable to redistribute the data traffic across multiple network devices, then the controller can select a set of network devices based on the controller-visible factors and the data traffic can be redistributed across those network devices based on the controller-visible factors.

Rather than allocating a network device from among the existing network devices, the controller can also enable allocation of a network device to replace existing network devices. Purposes for such a replacement can, for example, be to replace a lower-performance, older, and/or cheaper network device with a higher-performance, newer, and/or more expensive network device. Such replacement may be initiated by either the administrator or the tenant, and could be a source of billing income for the administrator when the tenant chooses to pay more for higher performance. As just described, removing such a network device to install a replacement network device can be performed without an impact to the end-user experience because not having any network device being more than 50% utilized would allow assignment of data traffic from the network device being replaced to an interim replacement network device that was not being more than 50% utilized.

A controller may be unable to dynamically increase performance (e.g., the throughput capability) of a single, non-virtualized network device. A network (e.g., a SDN, as described herein) can have a number of controllers that dynamically allocate network devices for the purpose of resiliency and/or scalability to improve performance. As described herein, controller-driven network device performance increases can be accomplished, for example, via load balancing. As presented in this disclosure, data traffic can, for example, be analyzed as upstream data traffic, which flows from controlled end-hosts to the core of the network, and downstream data traffic, which flows from the network core to the controlled end-hosts.

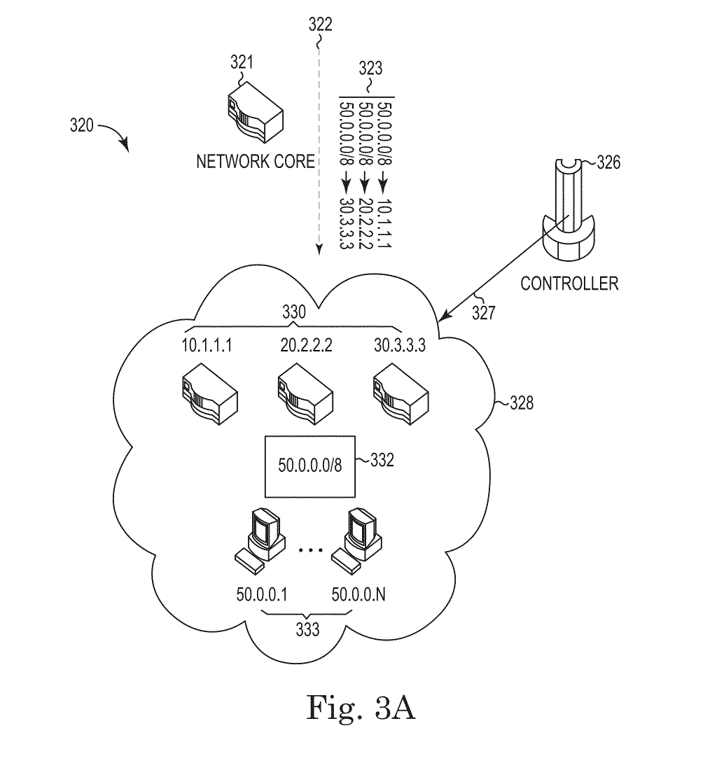

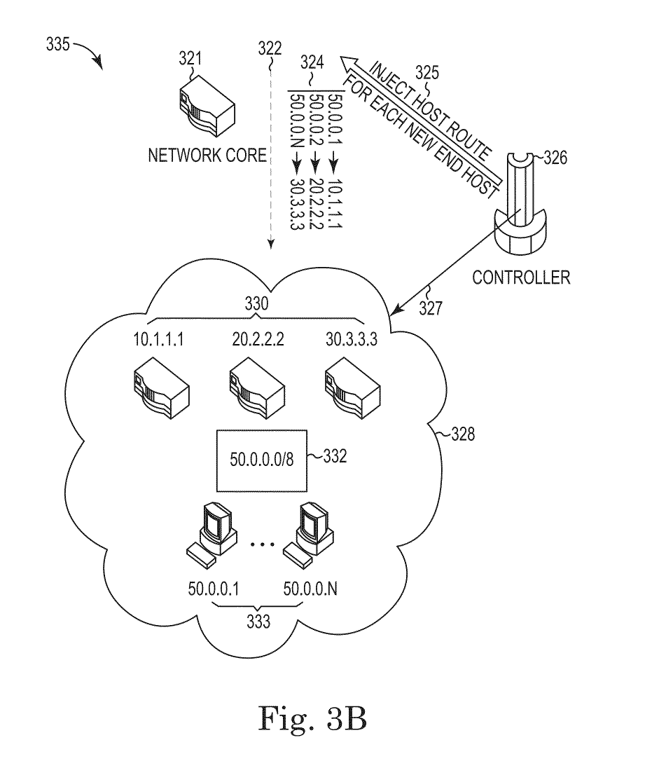

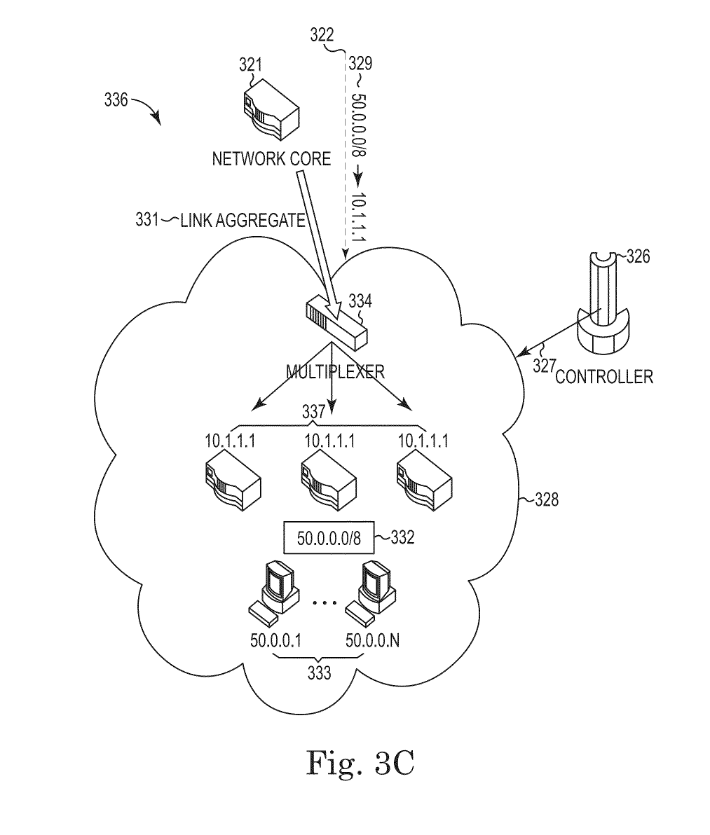

FIGS. 3A-3C illustrate block diagrams of examples of adjusting network device architecture for downstream data traffic according to the present disclosure. Adjusting the network device architecture for downstream data traffic can be performed by using one or more of the following techniques, which can include load balancing.

FIG. 3A illustrates a block diagram of an example of providing network device scalability 320 using load balancing according to the present disclosure. Improvement of scalability in the network (e.g., the SDN) can be accomplished by load balancing downstream data traffic 322 between a network core 321 (e.g., which, in some examples, is not being controlled by a controller 326) and a network data traffic functionality (e.g., an SDN). The downstream data traffic 322, including addressing 323 of the data traffic, can communicate with interfaces (not shown) of a number of network devices 330 (e.g., having addresses 10.1.1.1, 20.2.2.2, and 30.3.3.3, although not limited to three network devices) interfacing with the network core 321. In some examples, the network devices 330 can be accessed by the network core 321 in the cloud 328.

Load balancing of the downstream data traffic 322 can, for example, be performed using an equal-cost, multi-path (ECMP) protocol (e.g., such as an open shortest path first (OSPF) protocol, a border gateway protocol (BGP), etc.). The ECMP protocol can either be running in the network core 321 and/or in the cloud 328 to balance the load of the downstream data traffic 322 more equally according to its own parameters, while enabling the network (e.g., the SDN) to dynamically allocate (e.g., adding, removing, replacing, etc.) network devices to a data traffic pathway. The controller 326 can select 327 an appropriate one or more network devices from the number of network devices 330 for each subnetwork 332 (e.g., addresses 50.0.0.0, 50.0.0.1, . . . , 50.0.0.8, not limited to nine addresses) of a number of end-hosts 333 (e.g., end-hosts 50.0.0.1, . . . , 50.0.0.N) based on the controller-visible factors. The selected network device can inform the network core 321 of the destination subnetworks 332 that it has access to.

FIG. 3B illustrates a block diagram of another example of providing network device scalability 335 using load balancing according to the present disclosure. Improvement of scalability in the network (e.g., the SDN) can be accomplished by load balancing downstream data traffic 322 between a network core 321 and a network routing functionality (e.g., an SDN). The downstream data traffic 322 can communicate with interfaces (not shown) of a number of network devices 330 (e.g., having addresses 10.1.1.1, 20.2.2.2, and 30.3.3.3, although not limited to three network devices) interfacing with the network core 321.

In various examples, a data traffic pathway 324 for each for a number of end-hosts 333 (e.g., which can, for example, be end-hosts newly associated with a subnetwork 332) can be injected 325 into the network core 321. These data traffic pathways 324 can be injected from the controller 326 directly, or from another device associated with, for example, the SDN, based on the controller-visible factors. Each time a new network device 330 is allocated to the new end-host 333, the controller 326 can adjust the load balancing to include that new network device 330. The controller 326 can select 327 an appropriate one or more network devices from the number of network devices 330 for each new end-host 333 (e.g., end-hosts 50.0.0.1, . . . , 50.0.0.N) based on the controller-visible factors. The selected network device can inform the network core 321 of the destination subnetworks 332 that it has access to.

The load balancing of the downstream data traffic 322 can, for example, be performed using an ECMP protocol. The ECMP protocol can either be running in the network core 321 and/or in the cloud 328 to balance the load of the downstream data traffic 322 more equally according to its own parameters, while enabling the network (e.g., the SDN) to dynamically allocate (e.g., adding, removing, replacing, etc.) network devices to a data traffic pathway.

FIG. 3C illustrates a block diagram of an example of providing network device scalability 336 using a link aggregate functionality and load balancing according to the present disclosure. Improvement of scalability in the network (e.g., the SDN) can be accomplished by load balancing downstream data traffic 322 between a network core 321 and a network routing functionality (e.g., an SDN). The downstream data traffic 322, including addressing 329 of the data traffic, can communicate with a link aggregate functionality 331 of a number of network devices 337 (e.g., each having a common address 10.1.1.1, although not limited to three network devices) interfacing with the network core 321.

A component of the network infrastructure can operate as the link aggregate functionality 331 to direct data traffic by having a link aggregate on one side and a set of distinct links on the other side. The link aggregate functionality 331 can be a set of physical links that are grouped together to form one logical link. The link aggregate functionality 331 can be used for either upstream or downstream data traffic by facing a source of the data traffic. If the link aggregate functionality 331 is on the network core 321 side of the network devices 337 for downstream data traffic, as shown in FIG. 3C, the link aggregate functionality 331 can connect to the network core 321.

In some examples, the link aggregate functionality 331 can connect the network core 321 to a SDN of network devices 337. The link aggregate functionality 331 can operate as one logical link from the network core 321. As such, all the SDN of network devices 337 can direct data traffic for any units of data directed to a common network address (e.g., layer 3 (L3) as defined in the open systems interconnection (OSI) model (ISO/IEC 7498-1)) and a common data link address (e.g., layer 2 (L2) as defined in the OSI model, which can include logical link control (LLC), media access control (MAC), etc.) shared by all of the network devices 337. Hence, a data traffic protocol can be unnecessary. The link aggregate functionality 331 can assure that the network core 321 does not observe data link address moves, while also providing inherent load balancing.

When each link of the link aggregate functionality 331 is a direct physical connection to the network core 321, the level of performance of the SDN of network devices 337 may be limited by availability of physical network core links. When the SDN of network devices 337 is grouped (e.g., with one physical link per network device group), the performance may still have a limit. Overcoming such potential limitations can be accomplished by having a single high-capacity link aggregate functionality 331 between the network core 321 and a SDN multiplexer 334. The multiplexer 334 can enable a load balancing process to be software-defined such that the multiplexer 334 can perform load balancing across all of the SDN of the connected network devices 337. In various examples, the link aggregate functionality 331 and the multiplexer 334 can each be in the cloud 328, associated with the network core 321 out of the cloud 328, or the aggregate functionality 331 can be associated with the network core 321 out of the cloud 328 and the multiplexer 334 can be in the cloud 328, among other possible locations.

The multiplexer 334 can assure that the network core 321 does not observe data link address moves between ports. The multiplexer 334 would not use the source or destination data link addressing in load balancing calculations, because that addressing would remain constant for all downstream data traffic. Instead, the controller 326 can direct 327 the multiplexer 334 to use other criteria (e.g., source and/or destination Internet protocol (IP) addresses, protocol designations, protocol port numbers, and/or other appropriate information).

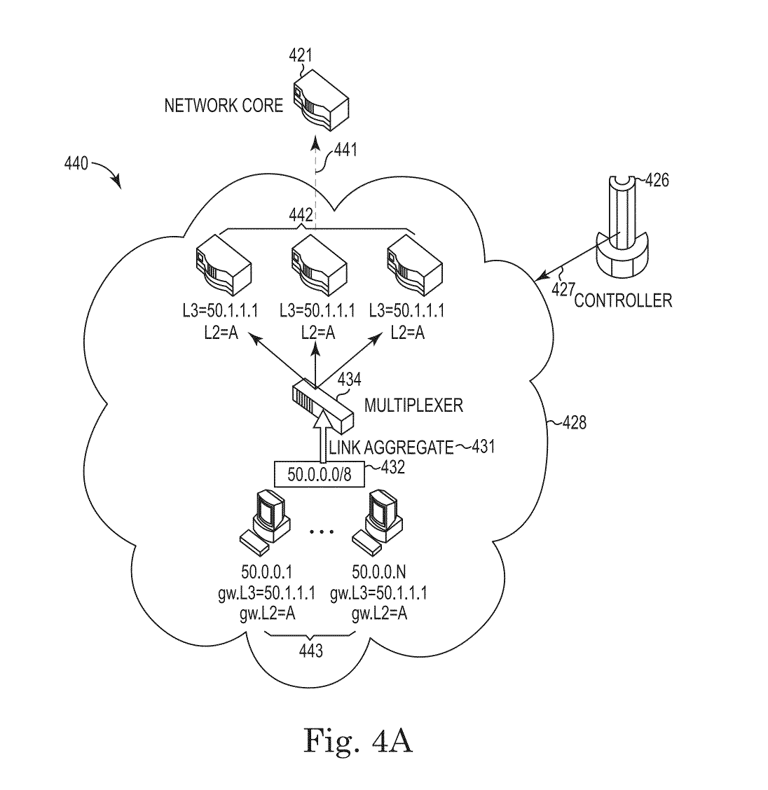

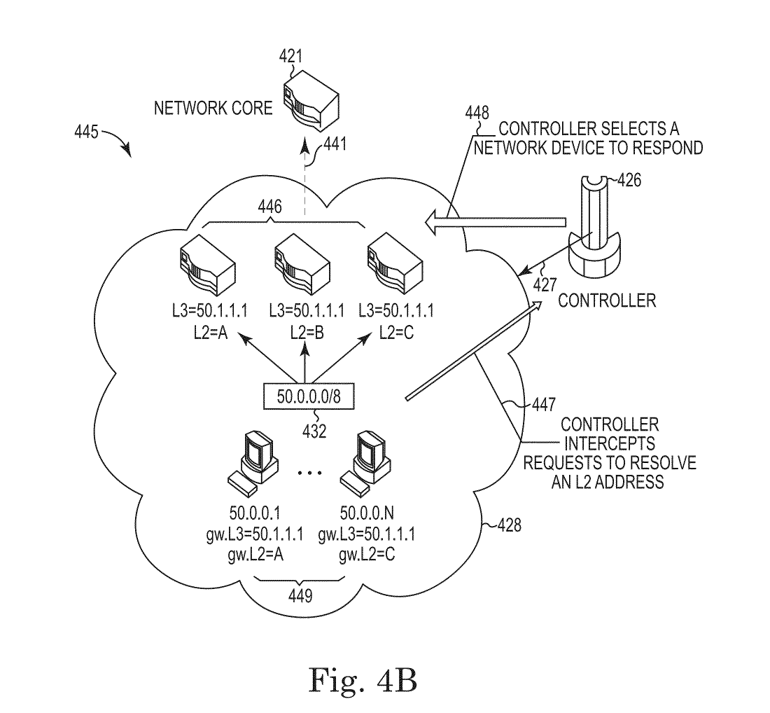

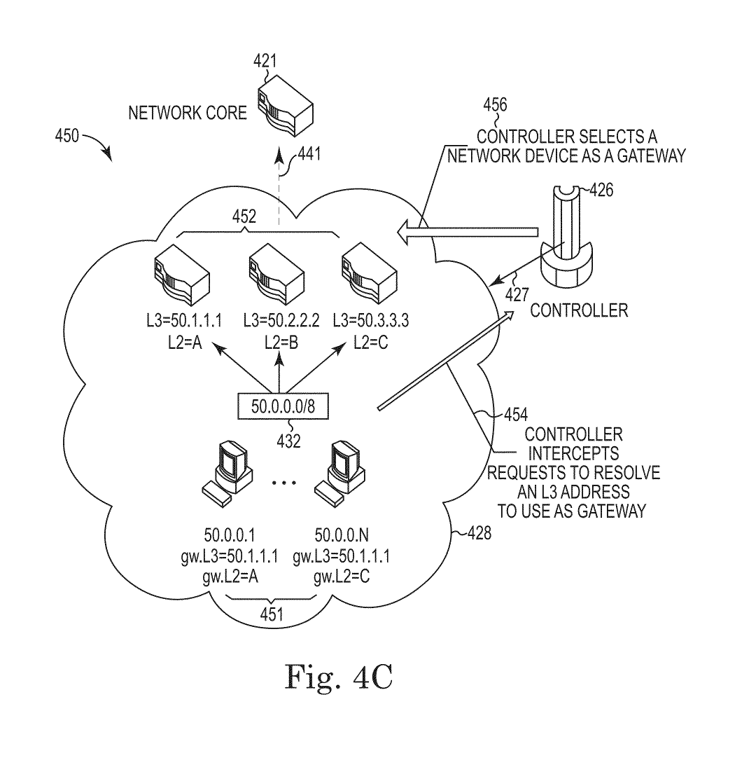

FIGS. 4A-4C illustrate block diagrams of examples of adjusting network device architecture for upstream data traffic according to the present disclosure. Adjusting the network device architecture for upstream data traffic can be performed by using one or more of the following techniques.

FIG. 4A illustrates a block diagram of an example of providing network device scalability 440 for upstream data traffic according to the present disclosure. Improvement of scalability in the network (e.g., the SDN) can be accomplished by load balancing upstream data traffic 441 between end-hosts 443 of the network and a network data traffic functionality (e.g., an SDN). The upstream data traffic, including addressing of the data traffic, can communicate with interfaces (not shown) of a number of network devices 442, each having a common network address (e.g., L3=50.1.1.1) and a common data link address (e.g., L2=A), although not limited to three network devices, interfacing with the end-hosts 443. In some examples, the network devices 442 can be accessed by the end-hosts 443 in the cloud 428. In some examples, the end-hosts 443 can be virtual end-hosts in the cloud 428.

As shown in FIG. 4A, a plurality of network devices 442 can share a common L3 address and a common L2 address. The plurality of network devices 442 can thus operate as a single virtual network device. The controller 426 can inform 427 the network devices 442 having the common L2 address that they are all enabled to be accessible on the downstream interfaces (e.g., facing the end-hosts 443). When each network device 442 forwards a unit of data toward the upstream network core 421, the common L2 address would not be used as a source L2 address in the unit of data (e.g., to avoid L2 moves in the network core).

On any given subnetwork 432, there can be one of the network devices 442 actively communicating data traffic for the common L2 address, although each of the plurality of network devices 442 can potentially be active simultaneously across a plurality of subnetworks (subnetwork 432 having addresses 50.0.0.0/8, which can start with 50.0.0.0 and continue through 50.255.255.255, although not limited to this number of addresses). When an active network device fails, the controller 426 can select 427 a different one of the network devices 442 to become active. Such a selection can be facilitated by having a relatively even amount of upstream data traffic from each subnetwork 432 for load balancing the data traffic. As such, the end-hosts 443 may remain uninformed concerning failure of a network device and/or alteration of load balancing.

In some examples, a link aggregate functionality 431 can be on the end-host 443 side of the network devices 442 for upstream data traffic and the link aggregate functionality can connect to the end-hosts 443 for each subnetwork 432. In some examples, a multiplexer 434 can enable a load balancing process to be software-defined such that the multiplexer 434 can perform load balancing across all of the SDN of the connected network devices 442. The multiplexer 424 can enable each of the network devices 442 to use the common L2 address as a source L2 address as well. Because the plurality of software-defined network devices 442 can operate as a single virtual network device, the multiplexer can assure that the plurality of network devices 442 does not receive more than one copy of each upstream unit of data. The multiplexer 434 can assure that the end-hosts 443 do not observe data link address moves. In various examples, the link aggregate functionality 431 and the multiplexer 434 can each be in the cloud 428, associated with end-hosts 443 not in the cloud 428, or the aggregate functionality 431 can be associated with the end-hosts 443 not in the cloud 428 and the multiplexer 434 can be in the cloud 428, among other possible locations. In some examples, the end-hosts 443 can be virtual end-hosts in the cloud 428.

FIG. 4B illustrates a block diagram of another example of providing network device scalability 445 for upstream data traffic according to the present disclosure. Improvement of scalability in the network (e.g., the SDN) can be accomplished by load balancing upstream data traffic 441 between end-hosts 449 of the network and the network data traffic functionality (e.g., an SDN). The upstream data traffic, including addressing of the data traffic, can communicate with interfaces (not shown) of a number of network devices 446, each having a common network address (e.g., L3=50.1.1.1) and a unique data link address (e.g., L2=A, B, and C), although not limited to three network devices, interfacing with the end-hosts 449. In some examples, the network devices 446 can be accessed in the cloud 428 by end-hosts 449 not in the cloud 428. In some examples, the end-hosts 449 can be virtual end-hosts in the cloud 428.

As shown in FIG. 4B, a plurality of network devices 446 can share a common L3 address and each can have a unique L2 address. The end-hosts 449 can initially be configured with a static gateway network device address (e.g., gw.L3=50.0.0.1). When one of the end-hosts 449 sends a request to resolve the common L3 address to an L2 address, the request can be intercepted by the controller 447. Based upon the controller-visible factors, as described herein, the controller 426 can select 425 which of the network devices 446 responds to the end-host 449 on behalf of the common L3 address. As such, more flexibility can be provided in load balancing. As such, in some examples, for upstream data traffic, a plurality of network devices 446 have a common network address and subsets (e.g., one or more of the plurality) each have a unique data link address and a plurality of end-hosts 449 each can have a static gateway network device address, where the controller 426 intercepts requests from the plurality of end-hosts to resolve the data link address 447 (e.g., with an address resolution (ARP) functionality) for network device selection 448 via the analysis of the controller-visible factors. In some examples, the controller itself can dynamically direct L3-to-L2 address resolution (e.g., depending upon the L2 and L3 addressing protocol).

FIG. 4C illustrates a block diagram of another example of providing network device scalability 450 for upstream data traffic according to the present disclosure. Improvement of scalability in the network (e.g., the SDN) can be accomplished for upstream data traffic 441 between end-hosts 451 of the network and the network data traffic functionality (e.g., an SDN). The upstream data traffic, including addressing of the data traffic, can communicate with interfaces (not shown) of a number of network devices 452, each having a unique network address (e.g., L3=50.1.1.1, 50.2.2.2, and 50.3.3.3) and a unique data link address (e.g., L2=A, B, and C), although not limited to three network devices, interfacing with the end-hosts 451. In some examples, the network devices 452 can accessed in the cloud 428 by end-hosts 451 not in the cloud 428. In some examples, the end-hosts 451 can be virtual end-hosts in the cloud 428.

As shown in FIG. 4C, a plurality of network devices 452 can each have a unique L3 address and each can have a unique L2 address. When an end-host is initialized and/or requests a gateway network device L3 address, the controller 426 can intercept the request to resolve an L3 address to use as a gateway 454 and can use controller-visible factors to determine a unique L3 address, which can be assigned to the end-host 451 as a gateway network device. That is, the controller 426 can select (e.g., with a dynamic host configuration protocol (DHCP) functionality) a network device 456 from the network devices 452 as a gateway network device to be assigned to the end-host 451. As such, in some examples, for upstream data traffic, a plurality of network devices 452 can each have a unique network address and subsets (e.g., one or more of the plurality) each have a unique data link address and allocation of a network address to a gateway network device address of an end-host can be resolved (e.g., by using a DHCP functionality) by interception of the request 454 from the end-host 451 by the controller 426 via the analysis of the controller-visible factors. In some examples, the controller itself can dynamically direct L3-to-L2 address resolution (e.g., depending upon the L2 and L3 addressing protocol).

As shown in FIG. 4C, the controller 426 can intercept DHCP queries to gain control over the L3 address being used as a gateway (“gw”) for each end-host 451. Depending upon the L3 addressing scheme used, the controller 426 can dynamically dictate the L3 address that each end-host 451 uses as its gateway.

When one or more of the network devices 452 fails, the controller 426 can intercede to assign a new gateway for whichever end-hosts 451 were previously using the failed network device as a gateway. Assigning the new gateway can be done (e.g., by reconfiguring the DHCP functionality or another functionality for dynamically assigning a new gateway) when the network device for the end-host fails. To trigger the end-host requesting a new network device assignment (e.g., from the DHCP functionality or another functionality for dynamically assigning a new gateway), the controller 426 can, in some examples, interrupt a physical link or a virtual link to the end-host. Depending upon the protocol chosen, link toggling may be used to re-initiate the gateway discovery process.

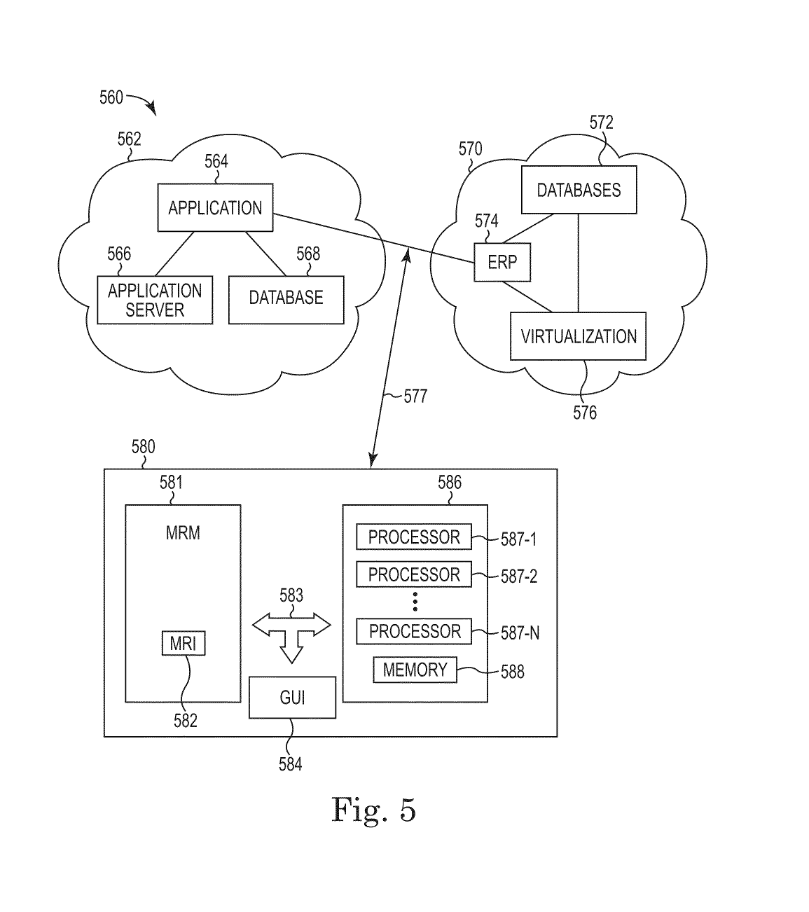

FIG. 5 illustrates a block diagram of an example system for adjusting network device architecture in a cloud according to the present disclosure. An example system 560 for adjusting network device architecture is described below as being implemented in the cloud by way of example and not by way of limitation. That is, in some examples of the present disclosure, adjusting network device architecture can be performed (e.g., at least partially) within an organization utilizing applications, as described herein, accessible and usable through wired communication connections in addition or as an alternative to through wireless communications.

In some examples, the system 560 illustrated in FIG. 5 can include a number of cloud systems. In some examples, the number of clouds can include a public cloud system 562 and a private cloud system 570. For example, an environment (e.g., an information technology (IT) environment for adjusting network device architecture) can include a public cloud system 562 and a private cloud system 570 that can include a hybrid environment and/or a hybrid cloud. A hybrid cloud, for example, can include a mix of physical server systems and dynamic cloud services (e.g., a number cloud servers). For example, a hybrid cloud can involve interdependencies between physically and logically separated services consisting of multiple systems. A hybrid cloud, for example, can include a number of clouds (e.g., two clouds) that can remain unique entities but that can be bound together.

The public cloud system 562, for example, can include a number of applications 564, an application server 566, and a database 568. The public cloud system 562 can include a service provider (e.g., the application server 566) that makes a number of the applications 564 and/or resources (e.g., the database 568) available to users (e.g., accessible and/or modifiable by business analysts, authorized representatives, sub-providers, tenants, end-users, and/or customers, among others) over the Internet, for example. The public cloud system 562 can be free or offered for a fee. For example, the number of applications 564 can include a number of resources available to the users over the Internet. The users can access a cloud-based application through a number of GUIs 584 (e.g., via an Internet browser). An application server 566 in the public cloud system 562 can include a number of virtual machines (e.g., client environments) to enable adjusting network device architecture, as described herein. The database 568 in the public cloud system 562 can include a number of databases that operate on a cloud computing platform.

The private cloud system 570 can, for example, include an Enterprise Resource Planning (ERP) system 574, a number of databases 572, and virtualization 576 (e.g., a number of virtual machines, such as client environments, to enable adjusting network device architecture, as described herein). For example, the private cloud system 570 can include a computing architecture that provides hosted services to a limited number of nodes (e.g., computers and/or virtual machines thereon) behind a firewall. The ERP 574, for example, can integrate internal and external information across an entire business unit and/or organization (e.g., of a cloud service provider). The number of databases 572 can include an event database, an event archive, a central configuration management database (CMDB), a performance metric database, and/or databases for a number of input profiles, among other databases. Virtualization 576 can, for example, include the creation of a number of virtual resources, such as a hardware platform, an operating system, a storage device, and/or a network resource, among others.

In some examples, the private cloud system 570 can include a number of applications and/or an application server, as described for the public cloud system 562. In some examples, the private cloud system 570 can similarly include a service provider that makes a number of the applications and/or resources (e.g., the databases 572 and/or the virtualization 576) available for free or for a fee (e.g., to business analysts, authorized representatives, sub-providers, tenants, end-users, and/or customers, among others) over, for example, a local area network (LAN), a wide area network (WAN), a personal area network (PAN), and/or the Internet, among others. The public cloud system 562 and the private cloud system 570 can be bound together, for example, through one or more of the number of applications (e.g., 564 in the public cloud system 562) and/or the ERP 574 in the private cloud system 570 to enable adjusting network device architecture, as described herein.

The system 560 can include a number of computing devices 580 (e.g., a number of IT computing devices, system computing devices, and/or cloud service computing devices, among others) having machine readable memory (MRM) resources 581 and processing resources 586 with machine readable instructions (MRI) 582 (e.g., computer readable instructions) stored in the MRM 581 and executed by the processing resources 586 to, for example, enable adjusting network device architecture, as described herein. In various examples, at least some of the number of computing devices 580 can form a system physically separate from a number of the applications and/or application servers associated with the private cloud system 570 and/or the public cloud system 562 (e.g., to enable dynamic interaction between a cloud service provider and a number of cloud service sub-providers).

The computing devices 580 can be any combination of hardware and/or program instructions (e.g., MRI) configured to, for example, enable adjusting network device architecture, as described herein. The hardware, for example, can include a number of GUIs 584 and/or a number of processing resources 586 (e.g., processors 587-1, 587-2, . . . , 587-N), the MRM 581, etc. The processing resources 586 can include memory resources 588 and the processing resources 586 (e.g., processors 587-1, 587-2, . . . , 587-N) can be coupled to the memory resources 588. The MRI 582 can include instructions stored on the MRM 581 that are executable by the processing resources 586 to execute one or more of the various actions, functions, calculations, data manipulations and/or storage, etc., as described herein.

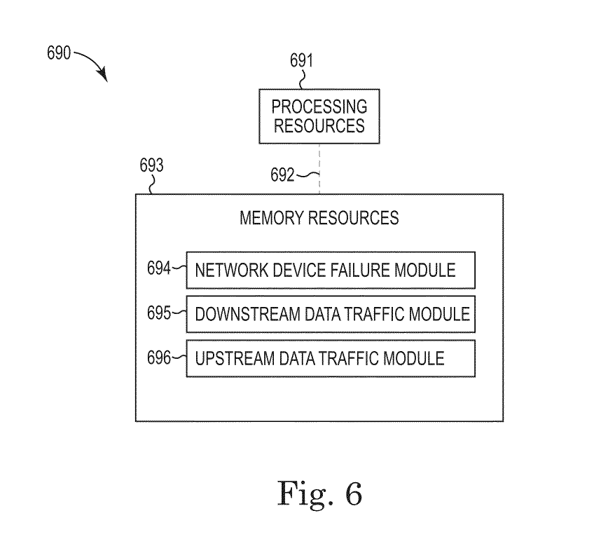

The computing devices 580 can include the MRM 581 in communication through a communication path 583 with the processing resources 586. For example, the MRM 581 can be in communication through a number of application servers (e.g., Java® application servers) with the processing resources 586. The computing devices 580 can be in communication with a number of tangible non-transitory MRMs 581 storing a set of MRI 582 executable by one or more of the processors (e.g., processors 587-1, 587-2, . . . , 587-N) of the processing resources 586. The MRI 582 can also be stored in remote memory managed by a server and/or can represent an installation package that can be downloaded, installed, and executed. The MRI 582, for example, can include and/or be stored in a number of modules as described with regard to FIG. 6.

Processing resources 586 can execute MRI 582 that can be stored on an internal or external non-transitory MRM 581. The non-transitory MRM 582 can be integral, or communicatively coupled, to the computing devices 580, in a wired and/or a wireless manner. For example, the non-transitory MRM 581 can be internal memory, portable memory, portable disks, and/or memory associated with another computing resource. A non-transitory MRM (e.g., MRM 581), as described herein, can include volatile and/or non-volatile storage (e.g., memory). The processing resources 586 can execute MRI 582 to perform the actions, functions, calculations, data manipulations and/or storage, etc., as described herein. For example, the processing resources 5860 can execute MRI 582 to enable adjusting network device architecture, as described herein.

The MRM 581 can be in communication with the processing resources 586 via the communication path 583. The communication path 583 can be local or remote to a machine (e.g., computing devices 580) associated with the processing resources 586. Examples of a local communication path 583 can include an electronic bus internal to a machine (e.g., a computer) where the MRM 581 is volatile, non-volatile, fixed, and/or removable storage medium in communication with the processing resources 586 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 583 can be such that the MRM 581 can be remote from the processing resources 586, such as in a network connection between the MRM 581 and the processing resources 586. That is, the communication path 583 can be a number of network connections. Examples of such network connections can include LAN, WAN, PAN, and/or the Internet, among others. In such examples, the MRM 581 can be associated with a first computing device and the processing resources 586 can be associated with a second computing device (e.g., computing devices 580). For example, such an environment can include a public cloud system (e.g., 562) and/or a private cloud system (e.g., 570) to enable adjusting network device architecture, as described herein.

In various examples, the processing resources 586, the memory resources 581 and/or 588, the communication path 583, and/or the GUIs 583 associated with the computing devices 580 can have a connection 577 (e.g., wired and/or wirelessly) to a public cloud system (e.g., 562) and/or a private cloud system (e.g., 570). The connection 577 can, for example, enable the computing devices 580 to directly and/or indirectly control (e.g., via the MRI 582 stored on the MRM 581 executed by the processing resources 586) functionality of a number of the applications 564 (e.g., selected from cloud services executable by a number of sub-providers, among other applications) accessible in the cloud. The connection 577 also can, for example, enable the computing devices 580 to directly and/or indirectly receive input from the number of the applications 564 accessible in the cloud. Moreover, in combination with the functionalities described herein, the connection 577 can, in some examples, provide an interface (e.g., through the GUIs 584) for accessibility business analysts, authorized representatives, sub-providers, tenants, end-users, and/or customers, among others).

In various examples, the processing resources 586 coupled to the memory resources 581 and/or 588 can enable the computing devices 580 to execute the MRI 582 to utilize a controller (e.g., which can be a one or more controllers either associated with the cloud or associated with a network core that is not in the cloud, among other configurations and having machine-readable instructions stored thereon) to adjust, via analysis of the controller-visible factors, an architecture of a plurality of network devices that communicate units of data. The controller can be utilized for a controller-driven load balance of units of data communicated between the plurality of network devices.

The network device architecture can, in various examples, be adjusted across a plurality of network devices based on a current load or a predicted load of the plurality of network devices, among other results of analyzing the controller-visible factors. The number of network devices allocated to an end-host can be adjusted based upon a level of resource utilization (e.g., a number and/or frequency of data units input by the end-host contributing to a load on the number of network devices) to more effectively and or efficiently allocate the network devices. In some examples, the controller is in control of a SDN of network devices and each of the units of data communicated between a network core and a number of end-hosts can be at least partially addressed by a network address (L3) and a data link address (L2).

For downstream data traffic, a functionality can, in various examples, be enabled to more equally balance units of data communicated through the plurality of network devices based upon network device selection via analysis of the controller-visible factors. For downstream data traffic, the controller can, in various examples, adjust the load balance each time a new network device is allocated to include the new network device and the controller can select which network device an end-host utilizes via the analysis of the controller-visible factors. For downstream data traffic, a link aggregate functionality can in various examples, connect a network core with a plurality of network devices that communicate units of data addressed to a common network address (L3) and a common data link address (L2). For upstream data traffic, a plurality of network devices can, in various examples, have a common network address (L3) and a common data link address (L2) and a subset (e.g., one or more) of the plurality of network devices can actively communicate for the common data link address until at least one network device fails, whereupon the controller can select another network device via the analysis of the controller-visible factors.

As described herein, an apparatus can be used to adjust network device architecture. Such an apparatus can include a controller that implements a configuration decision and/or a data traffic decision for at least one virtual network device that communicates units of data in a cloud for units of data communicated between a number of compute nodes (e.g., a physical computing resource subdividable into a number of VMs) and a number of virtual end-hosts. The apparatus can, in some examples, include a multiplexer in the cloud that load balances downstream data traffic from the number of compute nodes to the at least one virtual network device in the cloud and/or that ensures that an upstream unit of data from a virtual end-host is received by a single virtual network device (e.g., among a plurality of virtual network devices having a common network address (L3) and/or a common data link address (L2)). The controller can, in some examples, represent to a virtual end-host a virtual network device including a plurality of network devices such that a data traffic pathway of the end-host remains effective after failure of at least one network device.

FIG. 6 illustrates a block diagram of an example controller for adjusting network device architecture according to the present disclosure. The network controller 690 can be analogous to the network controllers 326, 426 illustrated in FIGS. 3A-3C and 4A-4C. The network controller 690 can utilize software, hardware, firmware, and/or logic to perform a number of functions.

The network controller 690 can be a combination of hardware and program instructions configured to perform a number of functions (e.g., actions). The hardware, for example, can include a number of processing resources 691 and a number of memory resources 693, such as the MRM 581 or other memory resources 588 illustrated in FIG. 5. The memory resources 693 can be internal and/or external to the network controller 690 (e.g., the network controller 690 can include internal memory resources and have access to external memory resources). The program instructions (e.g., machine-readable instructions (MRI)) can include instructions stored on the MRM to implement a particular function (e.g., such as adjusting network device architecture, as described herein). The set of MRI can be executable by one or more of the processing resources 691. The memory resources 693 can be coupled 692 to the processing resources 691 and to the network controller 690 in a wired and/or wireless manner. For example, the memory resources 693 can be an internal memory, a portable memory, a portable disk, and/or a memory associated with another resource (e.g., enabling MRI to be transferred and/or executed across a network such as the Internet).

The network controller 690 can include network device failure module 694, which can drive (e.g., determine and/or send instructions for) replacement of a failed network device with a standby network device and or forwarding of data throughput of a failed network device to another network device, as described, for example, with regard to FIGS. 2A and 2B. The network controller 690 can include a downstream data traffic module 695, which can drive (e.g., determine and/or send instructions for) adjustment of network device architecture for downstream data traffic, as described, for example, with regard to FIGS. 3A-3C. In addition, the network controller 690 can include an upstream data traffic module 696, which can drive (e.g., determine and/or send instructions for) adjustment of network device architecture for upstream data traffic, as described, for example, with regard to FIGS. 4A-4C.

Advantages of dynamically adjusting network device architecture, as described herein, can include an administrator being able to bill tenants individually based on the amount of network device throughput capacity and/or numbers of network devices they are using. As such, tenants may be billed for services they actually use rather than, for example, a straight service fee. The controller also can devote more network devices and/or higher-performance network devices to tenants who are willing to pay for them.

Controller-visible factors can give the controller an overarching view of the network that no single network device can enable. The controller can detect current patterns and/or predict future patterns in data traffic type and/or volume and, based thereon, can dynamically scale the network devices in reaction to and/or in anticipation of these patterns. This dynamic functionality can yield power savings (e.g., for unused network devices that are turned off), greater income (e.g., for unused network devices that are repurposed for financially profitable purposes), and/or greater performance in other areas.

Software-defined network device resiliency can enable network device failures to occur without notably affecting the end-user. Such failure periods could be intentionally initiated as part of an upgrade process, where lower performance network devices are swapped out with higher performance network devices, whereas such an upgrade may otherwise be difficult due to physical constraints. Software-defined network device resiliency and scalability contributing to improved performance can be a hands-off approach that allows the controller to apportion network devices consistent with a predefined algorithm without intervention of a possibly costly maintenance engineer.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource.

As described herein, plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

It is to be understood that the descriptions presented herein have been made in an illustrative manner and not a restrictive manner. Although specific examples systems, machine readable media, methods and instructions, for example, for dynamically adjusting network device architecture have been illustrated and described herein, other equivalent component arrangements, instructions, and/or device logic can be substituted for the specific examples presented herein without departing from the spirit and scope of the present disclosure.

The specification examples provide a description of the application and use of the systems, apparatuses, machine readable media, methods, and instructions of the present disclosure. Since many examples can be formulated without departing from the spirit and scope of the systems, apparatuses, machine readable media, methods, and instructions described in the present disclosure, this specification sets forth some of the many possible example configurations and implementations.

What is claimed:

1. A method of adjusting network device architecture, comprising:
sending a network decision from a controller to at least one network device that communicates units of data through a network infrastructure, the network decision based on information received from a number of network devices on the network infrastructure; and
adjusting a network device architecture for the at least one network device based on the network decision sent by the controller.

2. The method of claim 1, comprising adjusting the network device architecture across a plurality of network devices based on a current load or a predicted load of the plurality of network devices.

3. The method of claim 1, comprising adjusting a group of network devices to have at least one standby network device in an event of failure of at least one network device in the group of network devices for resiliency by forwarding throughput of a failed network device to the at least one standby network device.

4. The method of claim 1, comprising adjusting a plurality of network devices to utilize no more than a predetermined portion of a data throughput capacity for each network device for resiliency in an event of failure of at least one network device by forwarding throughput of a failed network device to at least one other network device.

5. The method of claim 1, comprising adjusting a number of network devices allocated to an end-host based upon a level of resource utilization.

6. A non-transitory machine-readable medium storing a set of instructions that, when executed, cause a processing resource to direct a controller to:
adjust, via analysis of controller-visible factors, an architecture of a plurality of network devices that communicate units of data; and
load balance units of data communicated between the plurality of network devices.

7. The medium of claim 6, wherein the controller is in control of a software-defined network of network devices and each of the units of data communicated between a network core and a number of end-hosts is at least partially addressed by a network address and a data link address.

8. The medium of claim 6, wherein for downstream data traffic a functionality is enabled to more equally balance the units of data communicated through the plurality of network devices based upon network device selection via the analysis of the controller-visible factors.

9. The medium of claim 6, wherein for downstream data traffic the controller adjusts the load balance each time a new network device is allocated to include the new network device and the controller selects which network device an end-host utilizes via the analysis of the controller-visible factors.

10. The medium of claim 6, wherein for downstream data traffic a link aggregate functionality connects a network core with a plurality of network devices that communicate units of data addressed to a common network address and a common data link address.

11. The medium of claim 6, wherein for upstream data traffic a plurality of network devices have a common network address and a common data link address and a subset of the plurality of network devices actively communicates for the common data link address until at least one network device fails, whereupon the controller selects another network device via the analysis of the controller-visible factors.

12. The medium of claim 6, wherein for upstream data traffic a plurality of network devices have a common network address and subsets each have a unique data link address and a plurality of end-hosts have a static gateway network device address, wherein the controller intercepts requests from the plurality of end-hosts to resolve the data link address for network device selection via the analysis of the controller-visible factors.

13. The medium of claim 6, wherein for upstream data traffic a plurality of network devices have a unique network address and subsets each have a unique data link address and allocation of a network address to a gateway network device address of an end-host is resolved by interception of a request from the end-host by the controller via the analysis of the controller-visible factors.

14. An apparatus to adjust network device architecture, comprising:
a controller that implements a configuration decision or a data traffic decision for at least one virtual network device that communicates units of data in a cloud for units of data communicated between a number of compute nodes and a number of virtual end-hosts.

15. The apparatus of claim 14, wherein the controller represents to a virtual end-host a virtual network device comprising a plurality of network devices such that a data traffic pathway of the end-host remains effective after failure of at least one network device.
